(19) United States
(12) Patent Application Publication
(10) Pub. No.: US 2016/0226869 A1
(43) Pub. Date: Aug. 4, 2016

(54) SYSTEM AND METHOD OF CONTROLLING NETWORK ACCESS

(71) Applicant: ALE USA INC., Calabasas, CA (US)

(72) Inventors: Sabarinathan VACHIRAVEL, Bangalore (IN); Nagaraju VADAKOPPULA, Bangalore (IN); Arvind Mollin KUBENDRAN, Bangalore (IN)

(21) Appl. No.: 14/608,889

(22) Filed: Jan. 29, 2015

(51) Int. Cl. H04L 29/06; G06F 21/31

(52) U.S. Cl. CPC H04L 63/0876; H04L 63/0892; G06F 21/31; H04L 63/10; H04L 63/20

(57) ABSTRACT

A method of accessing an enterprise network is provided. A request to access the enterprise network is received at a network access node from a user device. The request includes a device identifier associated with the user device. A network access request messages is transmitted from the network access node to an authorization and authentication node. The access request message includes information associated with the device identifier. A message granting the user device access to the network is received at the network access node from the authorization and authentication node. The message granting the user device access to the network includes an indication of network access associated with the user device. The user device is instructed to establish a network connection with the network access device based on the indication of network access associated with the user device.

### FIELD OF THE INVENTION

The present invention is directed to controlling network access in a communication network, and more particularly, to an improved system and method of controlling network access in an enterprise network.

### BACKGROUND

An enterprise network is a private communication network generally under the control of a single entity such as a company, organization, etc. User devices access an enterprise network by establishing communications with a network switch. Typically, in an enterprise network, each user device has been pre-authorized to gain access to the network. For example, a network administrator can install software onto the network device in order to reduce a threat to enterprise data security. However, identifying and installing software on each network device throughout the entire network is cumbersome and time consuming.

One way to reduce the need to install software on each network device is to configure static enforcement policies within a network switch. The network administrator can instruct each network switch to allow a specific network device to establish communications with the network. However, the user of the network device must first inform the network administrator of the desire to establish communication with the enterprise network. In addition, each network switch in the network has to be individually configured with all of the enforcement policies to allow each user device to establish communications at various locations throughout the network.

Therefore, a need exists for an improved system and method of accessing an enterprise network that prevents cumbersome configurations and widespread security software installation.

### SUMMARY OF THE INVENTION

An aspect of the invention provides a method of accessing an enterprise network. A request to access the enterprise network is received at a network access node from a user device. The request includes a device identifier associated with the user device. A network access request messages is transmitted from the network access node to an authorization and authentication node. The access request message includes information associated with the device identifier. A message granting the user device access to the network is received at the network access node from the authorization and authentication node. The message granting the user device access to the network includes an indication of network access associated with the user device. The user device is instructed to establish a network connection with the network access device based on the indication of network access associated with the user device.

Other aspects of the invention, including apparatus, articles, methods, systems, assemblies, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description, serve to explain the principles of the invention. In such drawings:

FIG. 1 illustrates an exemplary communication system according to an exemplary embodiment of the present disclosure.

FIG. 2 illustrates a signaling diagram of an exemplary method of establishing communication in a communication network according to an exemplary embodiment of the present disclosure.

FIG. 3 illustrates another exemplary method of establishing communication in a communication system according to an exemplary embodiment of the present disclosure.

FIG. 4 illustrates another exemplary communication system according to an exemplary embodiment of the present disclosure.

### DETAILED DESCRIPTION

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

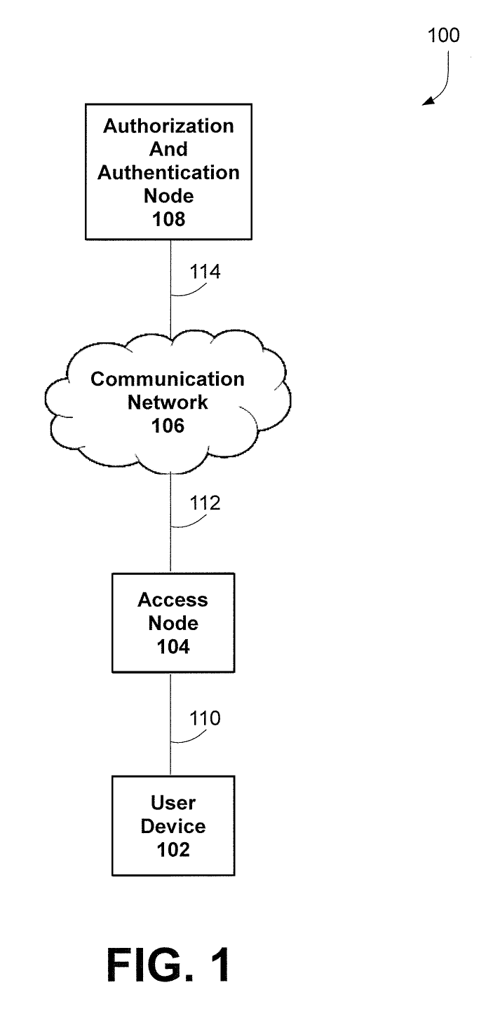

FIG. 1 illustrates a communication system 100 such as an enterprise network communication system. The system 100 includes a user device 102, a network access node 104, a communication network 106, and an authorization and authentication node 108. While only one user device 102 and one network access node 104 are illustrated, system 100 can include any number of user devices 102 and/or network access nodes 104. In addition, other network elements may be present to facilitate communication within system 100 which are omitted for clarity, including processing nodes, routers, gateways, and physical and/or wireless data links for carrying data among the various network elements.

User device 102 is any device configured to communicate over system 100 using a communication interface. For example, the user device 102 can be a wireless device such as a laptop, a smart phone, a tablet, a remote terminal unit, a printer, or any other wired or wireless enterprise device, and combinations thereof.

The user device 102 can transmit and/or receive information from network access node 104 over communication link 110. Communication link 110 can be wired or wireless and can use various communication media, such as air, space, metal, optical fiber, or some other signal propagation path—including combinations thereof.

The interface of the user device 102 includes one or more transceivers for transmitting and receiving data over communication system 100. In an exemplary embodiment, user device 102 can include a transceiver associated with a wired protocol, a wireless protocol, or a combination thereof. When the user device 102 is a wireless device, each transceiver can be associated with a different frequency band, the same or different radio access technologies, and/or the same or different network providers. For example, user device 102 can include a transceiver associated with at least one wireless cellular protocol and/or other types of wireless communication. For example, a transceiver can be associated with code division multiple access (CDMA), global system for mobile communications (GSM), worldwide interoperability for microwave access (WiMAX), long-term evolution (LTE), high-speed downlink packet access (HSDPA), IEEE 802.1x, wireless fidelity (WiFi), Bluetooth, Zigbee, infrared data association (IrDA), etc.

User device 102 can communicate information over system 100 using various communication services. For example, information communicated over system 100 can be transmitted in various voice and/or data forms such as voice over IP, email, internet links, digital messaging, graphic messaging, video messaging, audio messaging, text messaging, SMS messaging, etc.

User device 102 includes a processor and associated circuitry to execute or direct the execution of computer-readable instructions to obtain information. User device 102 retrieves and executes software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof. User device 102 can receive instructions and other input at a user interface. In an exemplary embodiment, the user interface of device 102 can include an input device such as a peripheral or a touch sensitive display to allow a user to input instructions associated with communications over the system 100.

Network access node 104 can be any network node configured to provide communication between user device 102 and communication network 106. The network access node 104 can be further configured to enforce network access policies such as client health or security policies, policies associated with connection request authentication, and/or policies associated with connection request authorization, etc. In an exemplary embodiment, network access node 104 can be an enterprise network switch.

Access node 104 can comprise a processor and associated circuitry to execute or direct the execution of computer-readable instructions to obtain information. Access node 104 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Authorization and authentication node 108 is any network node configured to authenticate user devices and/or authorize the user device 102 before granting access to system 100. Authorization and authentication node 108 can be a standalone computing device, computing system, or network component, and can be accessible, for example by a wired or wireless connection, or through an indirect connection such as through a computer network or communication network. In an exemplary embodiment, authentication node 108 can be an authentication, authorization, and accounting (AAA) node such as a RADIUS server.

Authorization and authentication node 108 can comprise a processor and associated circuitry to execute or direct the execution of computer-readable instructions to obtain information. Authorization and authentication node 108 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

In an exemplary embodiment, the authorization and authentication node 108 is configured to perform authentication based on a plurality of different protocols. For example, the authorization and authentication node 108 is configured with the required services to perform MAC authentication, 802.1X authentication, etc. which allows the authorization and authentication node 108 to perform authentication based on the request to access the network. The authorization and authentication node 108 can be further configured to identify a network access classification (e.g., an enforcement profile) and a user classification (e.g., the virtual local area network) associated with the user device 102 based on the type of authentication, such as the layer2 authentication mechanism (MAC, 802.1X).

Access node 104 is in communication with communication network 106 through communication link 112. Authorization and authentication node 108 is in communication with communication network 106 through communication link 114. Communication links 112, 114 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), or Long Term Evolution (LTE), or combinations thereof. Other wireless protocols can also be used. Links 112, 114 can be a direct link or might include various equipment, intermediate components, systems, and networks.

Communication network 106 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 106 can be capable of carrying data, for example, to support any of the voice or data services provided on the enterprise communication network system 100. Wireless network protocols can comprise code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), etc. Wired network protocols that may be utilized by communication network 106 comprise IEEE 802.1x, TCP/IP, Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), etc. Communication network 106 can also comprise additional access nodes, controller nodes, telephony switches, internet routers, network gateways, computer systems, communication links, or some other type of communication equipment, and combinations thereof.

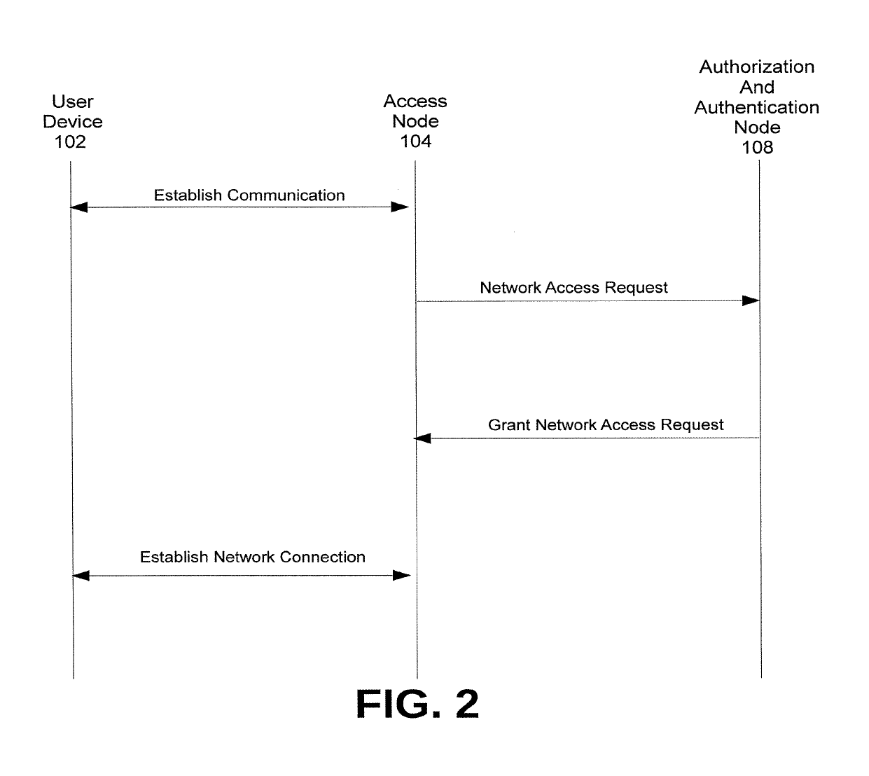

In operation, as best illustrated in the signaling diagram of FIG. 2, communication is initiated between a user device 102 and network access node 104. That communication can be initiated by either the user device 102 or the network access node 104. After communication is initiated, user device 102 transmits a request to access the enterprise network system 100 to the network access node 104, where the request to access the enterprise network includes device identifier information associated with the user device 102. The network access node 104 transmits a network access request message to the authorization and authentication node 108. The network access request message includes the device identifier information. The authorization and authentication node 108 determines whether the user device 102 is an authorized user of the system 100 based on the device identifier information. In an exemplary embodiment, a predetermined list of authorized devices can be stored at the authorization and authentication node 108. The authorization and authentication node 108 can compare the received device identifier information with the predetermined list of authorized devices and when the device identifier information corresponds to one of the devices on the predetermined list of authorized devices, the authorization and authentication node 108 determines that the user device 102 is an authorized user.

The authorization and authentication node 108 transmits a message instructing the access node to grant the user device 102 access to the enterprise network system 100 when the user device 102 is on the predetermined list of authorized devices. The message granting the user device 102 access to the enterprise network system 100 includes an indication of network access associated with user device 102. Based on the indication of network access associated with the user device 102, a network connection is established between the user device 102 and network access node 104 allowing user device 102 to access the enterprise network system 100. When the device identifier information does not correlate to any device listed in the predetermined list of authorized devices, the authorization and authentication node 108 transmits a message to the access node 104 instructing the access node 104 to deny network access to the user device 102.

In an exemplary embodiment, the network access node 104 is configured with the IP address of the authorization and authentication node 108 to allow the network access node 104 to establish a network connection with the authorization and authentication node 108. After a pre-authorized user device 102 initiates communication with the network access node 104, the network access node 104 sends a network access request message to the authorization and authentication node 108. If the IP address of the authorization and authentication node 108 is not configured at the network access node 104, the access node 104 may not generate the network access request message.

In addition, the IP address of the network access node 104 is configured at the authorization and authentication node 108. When the IP address of the network access node 104 is configured and stored at the authorization and authentication node 108, the authorization and authentication node 108 can determine which network access requests the authorization and authentication node 108 is to respond to based on the IP address. In an exemplary embodiment, the IP address of the network access node 104 may be communicated in a NAS-IP address attribute where the authorization and authentication node 108 compares the network access request including the NAS-IP address attribute with the IP address of the access node 104 that sent the network access request with IP addresses stored at the authorization and authentication node 108. When the IP address of the network access node 104 is stored at the authorization and authentication node 108, the authorization and authentication node 108 grants network access to the user device 102 associated with the network access request message. When the IP address of the network access node 104 associated with the network access request is not stored at the authorization and authentication node 108, the authorization and authentication node 108 denies the network access request preventing the user device 102 from gaining access to the communication system 100. In addition, the same IP address may be assigned to the network access node 104 and the authorization and authentication node 108 to allow the credentials associated with the user device 102 to be encrypted within messages between the network access node 104 and the authorization and authentication node 108 using a shared secret based on the shared IP address.

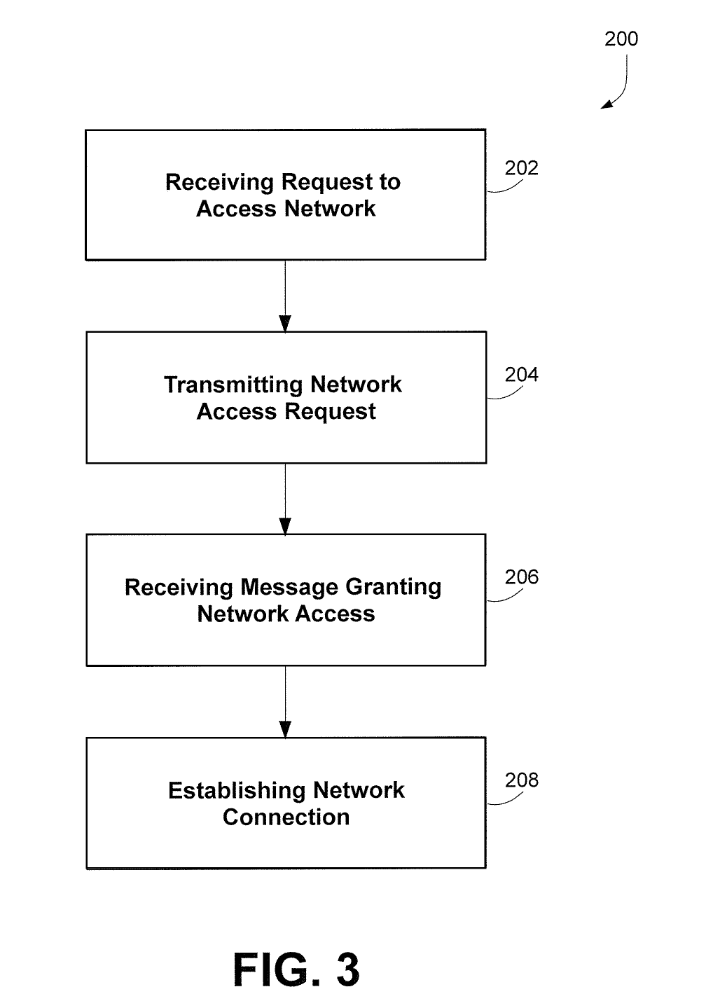

FIG. 3 illustrates a flow chart of an exemplary method 200 for communicating presence over a communication system. The method will be discussed with reference to the exemplary enterprise network communication system 100 illustrated in FIG. 1. However, the method can be implemented with any suitable communication system. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

At 202, a request to access the network is received. For example, after communication is established between user device 102 and network access node 104, user access device 102 transmits a request to access the enterprise network. The request to access the network includes a device identifier associated with the user device. The device identifier can be a universal identifier or a locally assigned identifier based on the classification type of the user associated with the user device 102. A universal identifier is an identifier assigned by the manufacturer at the time the user device 102 is manufactured. A locally assigned identifier is a temporary identifier assigned to the user device 102 by, for example, a network node of system 100 when the user device 102 is authorized to access the enterprise network system 100.

In an exemplary embodiment, the universal identifier is a media access control (MAC) address and the locally assigned address is an 802.1x address. When the user device 102 is associated with an employee or pre-authorized contractor of the entity associated with the enterprise network communication system 100, a network administrator will instruct a network node to assign the user device 102 associated with the employee or pre-authorized contractor a locally assigned address which is provided during the process of establishing communication between the user device 102 and the network access node 104. In addition, when the user device 102 is associated with an employee or pre-authorized contractor, the device identifier included in the request to access the network can further include user credentials such as a user name, password, security certificate, etc. When the user device 102 is unknown to the enterprise network communication system 100 such as when the user device 102 is associated with a guest that is not an employee or pre-authorized contractor, the information associated with the device identifier included in the request to access the enterprise network is the universal identifier of the user device 102.

A network access request message is transmitted from the network access node to an authorization and authentication node at 204. For example, a message including information associated with the device identifier is transmitted from the network access node 104 to the authorization and authentication node 108. In an exemplary embodiment, the authorization and authentication node 108 is a remote authentication dial in user service (RADIUS) server and the network access request message is a RADIUS Access-Request message including information associated with the device identifier of the user device 102.

In an exemplary embodiment, the authorization and authentication node 108 determines an indication of network access associated with the user device 102. The indication of network access includes a network access classification and/or a user classification. A network access classification can be unlimited, limited to select services such as voice only, data only, or a combination thereof, limited to a single service, etc. In an exemplary embodiment, the types of network access classification include full access, limited or partial access, and no access. Full access allows a user device 102 to use all services associated with system 100. Limited or partial access can restrict the user device 102 to select services. Alternatively, if the network classification is based on software stored at the user device 102 not being in compliance with the security policy, the network access node 104 can redirect the user device 102 to allow the user device 102 to rectify any software deficiencies such as by upgrading to suitable software. After the user device 102 has the appropriate software, the network access node 104 can allow the user device 102 to access the network. No access prevents the user device 102 from accessing the network.

A user classification can be an employee, a contractor, a guest, etc. In an exemplary embodiment, the authorization and authentication node 108 can be configured to allow network access based on a user classification where each user classification is associated with a different level of network access. Each network access request message from the network access node 104 includes an identification of the user classification. For example, based on the MAC address, authentication type, etc., associated with and/or included within the network access request message, the authorization and authentication node 108 can determine the type of user classification. In addition, the VSA and Filter-ID attributes may be configured on the service and if the network access request is serviced by a service, the VSA and Filter-ID are picked up from that service and sent to the network access node 104 in the RADIUS Access-Accept message

The authorization and authentication node 108 can determine the network access classification and/or user classification based on the information associated with the device identifier. For example, when the information associated with the device identifier is a universal identifier, the authorization and authentication node 108 determines that the user classification is a guest. When the information associated with the device identifier is a locally assigned address, the authorization and authentication node 108 determines the user classification based on a previously identified user classification stored in a data base associated with the locally assigned address, e.g., an employee or pre-authorized contractor. In an exemplary embodiment, the authorization and authentication node 108 identifies the classification based on the network access request message and compares that classification to a previously stored entry in the database. When attributes associated with the identified classification are found in the database, the authorization and authentication node 108 provides an identification of the attributes using the VSA and Filter-ID attributes in the message granting the user device 102 access to the system 100.

In an exemplary embodiment, when the user associated with the user device 102 is determined to be an employee of the company or organization, the user device 102 can be granted unlimited access to the enterprise network such as secure databases, etc. When the user associated with the user device 102 is determined to be a pre-authorized contractor, the user device 102 can be granted limited access to specific services of the enterprise network such as voice, data, etc. When the user associated with the user device 102 is determined to be a guest, the user device 102 can be granted limited access to a single service of the enterprise network to prevent any unauthorized security breaches.

At 206, a message granting the user device 102 access to the network is received at the network access node 104 from the authorization and authentication node 108. The message granting the user device 102 access to the enterprise network system 100 includes an indication of network access associated with the user device. The indication of network access can be an indication of network access classification and/or an indication of a user classification. In an exemplary embodiment, when the authorization and authentication node 108 is a RADIUS server, the authorization and authentication node 108 generates an Access-Accept message where the network access classification is indicated in the vendor specific attribute (VSA) portion of the Access-Accept message and the user classification is indicated in the Filter-Id attribute portion of the Access-Accept message. In an exemplary embodiment, the VSA and Filter-Id attributes are a plain text string included in the Access-Accept message that correspond to predetermined classifications and/or policies stored at the switch. After the network access node 104 receives the VSA and Filter-Id attributes, the rules associated with the VSA and Filter-Id attributes allow the network access node 104 to apply the corresponding classifications and/or policies regarding network access to the user device 102.

A network connection is established between the user device and the network access node based on the indication of network access associated with the user at 208. For example, the network access node 104 receives the message granting the user device access to the network from the authorization and authentication node 108. The indication of network access and/or the indication of a user classification generated at the authorization and authentication node 108 is a representation of the policies to be enforced by the network access node 104. The enforcement policies are stored at the network access node 104 and the network access node 104 selects the corresponding enforcement policy for the user device 102 based on the indication of network access and/or the indication of a user classification generated by the authorization and authentication node 108.

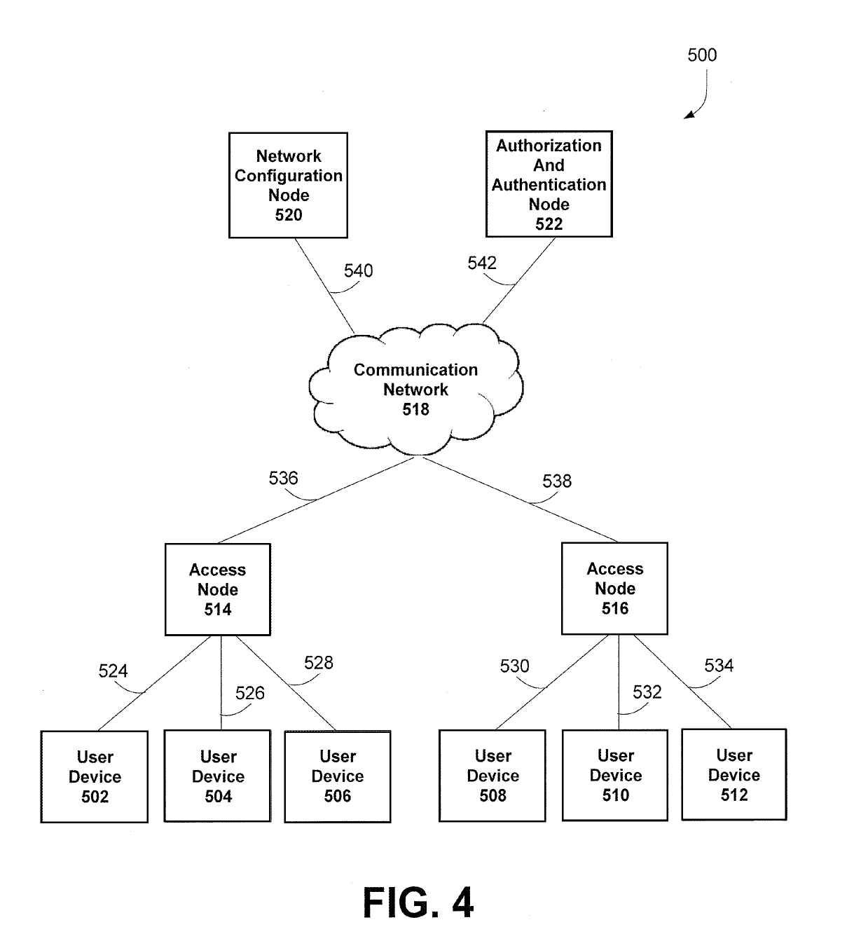

FIG. 4 illustrates a communication system 500 such as an enterprise network communication system. The system 500 includes user devices 502, 504, 506, 508, 510, 512, network access nodes 514, 516, a communication network 518, a local address assigning node 520, and an authorization and authentication node 522. While a plurality of user devices 502, 504, 506, 508, 510, 512 and two network access nodes 514, 516 are illustrated, system 500 can include any number of user devices 502, 504, 506, 508, 510, 512 and/or network access nodes 514, 516. In addition, other network elements may be present to facilitate communication within system 500 which are omitted for clarity, including processing nodes, routers, gateways, and physical and/or wireless data links for carrying data among the various network elements.

User devices 502, 504, 506, 508, 510, 512 are any device configured to communicate over system 500 using a communication interface. For example, user devices 502, 504, 506, 508, 510, 512 can be at least one of a wireless device such as a laptop, a smart phone, a tablet, a remote terminal unit, a printer, or any other wired or wireless enterprise device, and combinations thereof.

The user devices 502, 504, 506 transmit and/or receive information from network access node 514 over communication links 524, 526, 528 and user devices 508, 510, 512 transmit and/or receive information from network access node 516 over communication links 530, 532, 534. Communication links 524, 526, 528, 530, 532, 534 can be wired or wireless and can use various communication media, such as air, space, metal, optical fiber, or some other signal propagation path—including combinations thereof.

The interface of the user devices 502, 504, 506, 508, 510, 512 includes one or more transceivers for transmitting and receiving data over communication system 100. In an exemplary embodiment, user devices 502, 504, 506, 508, 510, 512 can include a transceiver associated with a wired protocol, a wireless protocol, or a combination thereof. When the user device 502, 504, 506, 508, 510, 512 is a wireless device, each transceiver can be associated with a different frequency band, the same or different radio access technologies, and/or the same or different network providers. For example, user device 502, 504, 506, 508, 510, 512 can include a transceiver associated with at least one wireless cellular protocol and/or other types of wireless communication. For example, a transceiver can be associated with code division multiple access (CDMA), global system for mobile communications (GSM), worldwide interoperability for microwave access (WiMAX), long-term evolution (LTE), high-speed downlink packet access (HSDPA), IEEE 802.1x, wireless fidelity (WiFi), Bluetooth, Zigbee, infrared data association (IrDA), etc.

User devices 502, 504, 506, 508, 510, 512 can communicate information over system 500 using various communication services. For example, information communicated over system 500 can be transmitted in various voice and/or data forms such as voice over IP, email, internet links, digital messaging, graphic messaging, video messaging, audio messaging, text messaging, SMS messaging, etc.

User devices 502, 504, 506, 508, 510, 512 include a processor and associated circuitry to execute or direct the execution of computer-readable instructions to obtain information. User devices 502, 504, 506, 508, 510, 512 retrieves and executes software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof. User devices 502, 504, 506, 508, 510, 512 can receive instructions and other input at a user interface. In an exemplary embodiment, the user interface of devices 502, 504, 506, 508, 510, 512 can include an input device such as a peripheral or a touch sensitive display to allow a user to input instructions associated with communications over the system 500.

Network access nodes 514, 516 can be any network node configured to provide communication between user devices 502, 504, 506, 508, 510, 512 and communication network 518. The network access nodes 514, 516 can be further configured to enforce network access policies such as client health or security policies, policies associated with connection request authentication, and/or policies associated with connection request authorization, etc. In an exemplary embodiment, network access nodes 514, 516 can be enterprise network switches.

Access nodes 514, 516 can comprise a processor and associated circuitry to execute or direct the execution of computer-readable instructions to obtain information. Access nodes 514, 516 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Network configuration node 520 is configured to provide dynamically distribute network configuration parameters, such as IP addresses for interfaces and services. In an exemplary embodiment, the network configuration node 520 is a dynamic host configuration protocol server. The network configuration node 520 can assign an IP address to a user device 502, 504, 506, 508, 510, 512 after the user classification has been determined for the corresponding user device 502, 504, 506, 508, 510, 512.

Network configuration node 520 can comprise a processor and associated circuitry to execute or direct the execution of computer-readable instructions to obtain information. Network configuration node 520 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Authorization and authentication node 522 is any network node configured to authenticate user devices and/or authorize the user devices 502, 504, 506, 508, 510, 512 before granting access to system 500. Authorization and authentication node 522 can be a standalone computing device, computing system, or network component, and can be accessible, for example by a wired or wireless connection, or through an indirect connection such as through a computer network or communication network. In an exemplary embodiment, authorization and authentication node 522 can be an authentication, authorization, and accounting (AAA) node such as a RADIUS server.

Authorization and authentication node 522 can comprise a processor and associated circuitry to execute or direct the execution of computer-readable instructions to obtain information. Authorization and authentication node 522 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

In an exemplary embodiment, the authorization and authentication node 522 is configured to perform authentication based on a plurality of different protocols. For example, the authorization and authentication node 522 is configured with the required services to perform MAC authentication, 802.1X authentication, etc. which allows the authorization and authentication node 522 to perform authentication based on the request to access the network. The authorization and authentication node 522 can be further configured to identify a network access classification (e.g., an enforcement profile) and a user classification (e.g., the virtual local area network) associated with the user devices 502, 504, 506, 508, 510, 512 based on the type of authentication, such as the layer2 authentication mechanism (MAC, 802.1X).

Access node 514 is in communication with communication network 518 through communication link 536. Access node 516 is in communication with communication network 518 through communication link 538. Network configuration node 520 is in communication with communication network 518 through communication link 540. Authorization and authentication node 522 is in communication with communication network 518 through communication link 542. Communication links 536, 538, 540, 542 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), or Long Term Evolution (LTE), or combinations thereof. Other wireless protocols can also be used. Links 536, 538, 540, 542 can be a direct link or might include various equipment, intermediate components, systems, and networks.

Communication network 518 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 518 can be capable of carrying data, for example, to support any of the voice or data services provided on the enterprise communication network system 500. Wireless network protocols can comprise code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), etc. Wired network protocols that may be utilized by communication network 518 comprise IEEE 802.1x, TCP/IP, Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), etc. Communication network 518 can also comprise additional access nodes, controller nodes, telephony switches, internet routers, network gateways, computer systems, communication links, or some other type of communication equipment, and combinations thereof.

In operation, communication is initiated between a user device 502, 504, 506, 508, 510, 512 and network access nodes 514, 516, respectively. That communication can be initiated by either the user devices 502, 504, 506, 508, 510, 512 or the network access nodes 514, 516. After communication is initiated, the user devices 502, 504, 506, 508, 510, 512 transmit a request to access the enterprise network system 500 to the respective network access node 514, 516, where the request to access the enterprise network includes device identifier information associated with the user device 502, 504, 506, 508, 510, 512. Each network access node 514, 516 transmits a network access request message to the authorization and authentication node 522. The network access request message includes the device identifier information. The authorization and authentication node 522 determines whether the user device 502, 504, 506, 508, 510, 512 is an authorized user of the system 500 based on the device identifier information. In an exemplary embodiment, a predetermined list of authorized devices can be stored at the authorization and authentication node 522. The authorization and authentication node 522 can compare the received device identifier information with the predetermined list of authorized devices and when the device identifier information corresponds to one of the devices on the predetermined list of authorized devices, the authorization and authentication node 522 determines that the user device 502, 504, 506, 508, 510, 512 is an authorized user.

The authorization and authentication node 522 transmits a message instructing the access node 514, 516 to grant the user device 502, 504, 506, 508, 510, 512 access to the enterprise network system 500 when the user device 502, 504, 506, 508, 510, 512 is on the predetermined list of authorized devices. The message granting the user device 502, 504, 506, 508, 510, 512 access to the enterprise network system 500 includes an indication of network access associated with user device 502, 504, 506, 508, 510, 512. Based on the indication of network access associated with the user device 502, 504, 506, 508, 510, 512, a network connection is established between the user device 502, 504, 506, 508, 510, 512 and network access node 514, 516 respectively, allowing user device 502, 504, 506, 508, 510, 512 to access the enterprise network system 500. When the device identifier information does not correlate to any device listed in the predetermined list of authorized devices, the authorization and authentication node 522 transmits a message to the access node 514, 516 instructing the access node 514, 516 to deny network access to the user device 502, 504, 506, 508, 510, 512. It is noted that the indication of network access associated with the user device 502, 504, 506, 508, 510, 512 is only sent to the access node 514, 516 in which the network access request originated.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

What is claimed is:

1. A method of accessing an enterprise network, comprising:
receiving at a network access node a request to access the enterprise network from a user device, wherein the request includes a device identifier associated with the user device;
transmitting a network access request message from the network access node to an authorization and authentication node, wherein the access request message include information associated with the device identifier;
receiving at the network access node a message granting the user device access to the network from the authorization and authentication node, wherein the message granting the user device access to the network includes an indication of network access associated with the user device; and
instructing the user device to establish a network connection with the network access device based on the indication of network access associated with the user device, wherein the network access node instructs the user device to establish the network connection.

2. The method of claim 1, wherein the device identifier is a universal identifier or a locally assigned identifier.

3. The method of claim 2, wherein the universal identifier includes information associated with a media access control address and the locally assigned identifier includes information associated with an 802.1x address.

4. The method of claim 1, wherein the device identifier further includes user credentials.

5. The method of claim 4, wherein the user credentials include at least one of a user name, password, and security certificate.

6. The method of claim 1, wherein the indication of network access associated with the user device includes a network access classification and a user classification.

7. The method of claim 6, wherein the user device is instructed to establish the network connection based on the user classification.

8. The method of claim 6, wherein the network access classification is provided in a vendor specific attribute of a RADIUS Access-Accept message.

9. The method of claim 6, wherein the user classification is provided in a Filter-ID attribute of a RADIUS Access-Accept message.

10. The method of claim 1, further comprising receiving from the authorization and authentication node instructions associated with a plurality of enforcement policies and at least one of a predetermined list of network access classifications and a predetermined list of user classifications, wherein each network access classification corresponds to a different enforcement policy to be enforced by the network access node.

11. A system of accessing an enterprise network, comprising:
a user device;
an authorization and authentication node; and
a network access node, wherein the network access node is configured to receive a request to access the enterprise network from the user device, wherein the request includes a device identifier associated with the user device,
transmit a network access request message to the authorization and authentication node, wherein the access request message includes information associated with the device identifier,
receive a message granting the user device access to the network from the authorization and authentication node, wherein the message granting the user device access to the network includes an indication of network access associated with the user device, and
instruct the user device to establish a network connection with the network access device based on the indication of network access associated with the user device.

12-20. (canceled)

21. A device for accessing an enterprise network, comprising:
a network access node, wherein the network access node is configured to
receive a request to access the enterprise network from a user device, wherein the request includes a device identifier associated with the user device,
transmit a network access request message to an authorization and authentication node, wherein the access request message includes information associated with the device identifier,
receive a message granting the user device access to the network from the authorization and authentication node, wherein the message granting the user device access to the network includes an indication of network access associated with the user device, and
instruct the user device to establish a network connection with the network access device based on the indication of network access associated with the user device.

22. The device of claim 21, wherein the device identifier is a universal identifier or a locally assigned identifier.

23. The device of claim 22, wherein the universal identifier includes information associated with a media access control address and the locally assigned identifier includes information associated with an 802.1x address.

24. The device of claim 21, wherein the device identifier further includes user credentials.

25. The device of claim 21, wherein the indication of network access associated with the user device includes a network access classification and a user classification.

26. The device of claim 25, wherein the user device is instructed to establish the network connection based on the user classification.

27. The device of claim 25, wherein the network access classification is provided in a vendor specific attribute of a RADIUS Access-Accept message.

28. The device of claim 25, wherein the user classification is provided in a Filter-ID attribute of a RADIUS Access-Accept message.

29. The device of claim 21, wherein the network access node is further configured to
receive from the authorization and authentication node instructions with a plurality of enforcement policies and at least one of a predetermined list of network access classifications and a predetermined list of user classifications, wherein each network access classification corresponds to a different enforcement policy to be enforced by the network access node.
